(19) United States
(12) Patent Application Publication
(10) Pub. No.: US 2007/0192182 A1
(43) Pub. Date: Aug. 16, 2007

(54) Method of delivering coupons using customer data

(76) Inventors: Tovin Monaco, Issaquah, WA (US); Russell Neville, Redmond, WA (US)

Correspondence Address: HOWISON & ARNOTT, L.L.P, P.O. BOX 741715, DALLAS, TX, 75374-1715, US

(21) Appl. No.: 11/352,914

(22) Filed: Feb. 10, 2006

(51) Int. Cl. G06Q 30/00

(52) U.S. Cl. 705/14

(57) ABSTRACT

A system architecture and method are provided that allow a retailer to provide a unique shopping experience to their customers. The customers, who belong to multiple affinity groups and have a purchasing history, are provided coupons via a wireless mobile device at the time they enter a zone on or about a retail location. The customer may use their wireless mobile device to select coupons or incentives for items that they wish to purchase in the store and thereby receive a discount. Retailers and product manufacturers may incentivise customers to purchase their goods at or near the point of product selection.

### CROSS-REFERENCE TO RELATED APPLICATIONS

This patent application is related to patent applications SYSTEM AND METHOD FOR ON-DEMAND DELIVERY OF MEDIA PRODUCTS, Docket No. CYPH-27,546; and SYSTEM AND ARCHITECTURE FOR PROVIDING RETAIL BUYING OPTIONS TO CONSUMER USING CUSTOMER DATA, Docket No. CYPH-27,545; all filed concurrently on the same date of Feb. 10, 2006 and all are hereby incorporated by reference.

### BACKGROUND OF THE INVENTION

Embodiments of the present invention are related to a system, architecture and method that provides a retail buying experience to consumers using real time customer data, and more particularly, a system, architecture and method that provides specific customer-oriented marketing via a wireless communication system, while a customer is in a store or retail location.

The retail buying experience has changed very little in the past decades. Customers received coupons via mail and sometimes via email long before they enter a store in which the coupons are valid.

The coupons are provided to all customers of a store regardless of the customer's purchasing history or interests. Many customers belong to multiple affinity groups or programs. An affinity group is a group like an airlines mileage program where a member gets points for spending money on services or at different retailers. For example, the American Automobile Association (AAA) is an affinity group that provides travel and map services as well as discounts to customers at various locations across the country. COSTCO is an affinity group that is a discount wholesaler, which also provides additional services and discounts to its customers. Weight Watchers is yet another example of an affinity group that provides services and suggestions to its members for weight loss techniques and diet plans. There are literally thousands of different affinity groups that have consumer members who have interests in what the particular affinity group or groups have to offer. At present, these affinity groups and consumer memberships to the same are not being fully used by stores, merchants or marketing entities to incentivise customers to select products or services in real time while the customers are in a particular store. In most cases, marketing efforts by stores or marketing groups are based on off-line messages or coupons that are pushed to customers via newspapers, regular mail, or email but may not be available to a customer during a retail shopping experience or near the point of purchase. That is, presently stores and marketing groups have a very limited ability to market to a customer while they are in a store deciding what to buy and researching what is the best deal.

What is needed is a system and method that allows a customer to be informed while they are in a store so that they can make decisions that are more informed at the time they are making a product selection or purchase. Furthermore, what is needed is a system and method that markets and provides purchasing incentives to customers, in real time, while they are in a retail store in such a manner that the incentives or coupons are based on the specific customer's historic purchases and affinity interests.

### SUMMARY OF THE INVENTION

Embodiments of the present invention provide a system and method that is used to market and provide purchasing incentives to customers, in real time, while they are in or near a retail store location. The purchasing incentives are provided, via a user's mobile device, in the form of videos, text, or other multimedia means. The incentives or coupons provided to the customer are based on the specific customer's historic purchases, affinity interests and/or other specific customer data or information acquired by embodiments of the present invention.

In one embodiment of the invention, a method of providing customer related messages to a customer, via the customer's mobile device, is explained. The customer's mobile device has a customer identification associating the customer with the mobile device. The method includes the customer entering a store zone. A system operating in the store zone receives the customer's identification from the customer's mobile device. The system then uses the customer identification to mine for customer demographic data related to the customer's identification. The system then generates messages targeted to the customer's interests, affinities and historic purchasing events. Providing the messages to the customer's mobile device when the mobile device enters the store zone. The customer may then be requested, via his mobile device, to review the messages on his mobile device and to select at least one of the messages that interests the customer. The customer's selections are received by the system. The system of the exemplary method then provides a discount to the customer, wherein the discount is applicable when the customer purchases an item that was the object of the message selected by the customer on the customer's mobile device. The store zone may be in, around, or about a retail store location.

In another embodiment of the invention, the discount that is provided to the customer is only provided when the mobile device and the customer are both at the point of sale, wherein an item related to the selected message is being purchased.

In yet another embodiment of the invention, the messages provided to the mobile device, comprise at least one of a coupon message, an incentive message and a product-offering message.

In yet another embodiment of the present invention, the discount provided to the customer is a larger discount, if the customer selected a message than if the customer only reviewed a message and did not select or indicate an interest in one of the items in the message.

In yet another embodiment of the invention, the mining of information about the customer further comprises requesting information relating to the customer's identification from at least one customer interest affinity database. Such request to an affinity database is made in real time as the customer is identified, via the customer's mobile device, when they enter the store zone.

In another embodiment of the invention, a method of providing purchasing incentives to a customer who enters a retail zone with a mobile device is provided. The mobile device contains a customer identification. The method comprises identifying the customer by receiving the customer identification from the customer's mobile device when the customer and the mobile device enter a retail zone. The method then provides to the customer's mobile device, a plurality of purchasing incentives. The plurality of purchasing incentives are based on a real time search and investigation into the customer's purchasing history and at least one of the customer's affinity memberships. The purchasing incentives are provided to the mobile device for the customer to review while either entering or nearing the zone. The method further includes, requesting that the customer review the plurality of purchasing incentives on the customer's mobile device and further requests that the customer selects at least one of the purchasing incentives indicating that the customer is interested in purchasing an item related to the purchasing incentive. The method further provides a discount to the customer at the point of sale. The discount is related to the selection of the purchasing incentive that the customer made via the customer's mobile device.

In some embodiments of the present invention, the method provides a purchasing incentive to the customer's mobile device in the form of at least one of a text media, a graphics media, or a video media.

In yet another embodiment of the present invention, another method of purchasing retail items with electronic coupons is provided. The exemplary method comprises of providing to a user's mobile device a plurality of electronic coupons. The plurality of electronic coupons are provided to the user's mobile device as the user's mobile device enters a predefined zone. The electronic coupons are, at least in part, a result of real time researched customer demographic data that is directly associated with the user of the user's mobile device. The method requests that the user review the plurality of electronic coupons on the user's mobile device. The user may select from the plurality of electronic coupons and after selecting one or more of the electronic coupons, the user may be provided directions to help the customer locate items that are the topic of the selected electronic coupons. The method further provides a discount to the user at the point of sale based on the selected electronic coupons that the user selected upon entering the retail zone. This exemplary method provides an advertising and marketing technique that provides coupons to a customer while they are deciding what products to purchase in a retail location. The customer may be rewarded by reviewing the real time or “just in time” coupons and selecting therefrom by receiving a discount upon selecting a coupon and purchasing the object item of the coupon.

It is understood that the above summary of the invention is not intended to represent each embodiment or every aspect of the present invention.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates an exemplary system architecture of an embodiment of the present invention;

FIG. 2 illustrates an exemplary flow diagram of a marketing method according to an embodiment of the invention; and

FIG. 3 illustrates a combination exemplary system and flow diagram of another embodiment of the invention.

### DETAILED DESCRIPTION OF THE PRESENT PREFERRED EMBODIMENTS OF THE INVENTION

Referring now to the drawings, wherein like reference numbers are used herein to designate like elements throughout the various views. Embodiments of the present invention are illustrated and described and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based upon the following examples of possible and exemplary embodiments of the present invention.

Embodiments of the invention provide a system architecture and describes various exemplary processes that allow a retailer to provide an improved shopping experience to their customers wherein each customer can be delivered messages based on the individual customer's demographic data. The messages targeted specifically to the wants, needs and interests of that specific customer while the customer is in or near the retail environment. Most customers belong to multiple affinity groups, including perhaps, the retailer or store's own affinity group (i.e., a customer loyalty program). Embodiments of the invention may include a means for involve identifying the customer via their wireless mobile device as they walk into a store or store zone that is covered by an exemplary system or service.

Once the identity of the customer is determined, relevant, demographic, affinity, and historic buying behaviors and other related information (collectively, “customer demographic data or CDD”) are assessed by the exemplary system and assembled in real time. The CDD profile for the customer is then used to then drive a market intelligence engine, which creates, assembles and delivers specific messages that target the customer's historic and CDD related interests. These messages can be delivered to the customer via the customer's wireless mobile device. The messages that are delivered to the customer may focus on particular interest groups, products, product locations within the store, pricing of the products within the store, methods of using the products within the store (for example, recipes) as well as provide coupons, incentives and other types of special pricing schemes or deals that apply to the specific customer. The marketing, coupons, special pricing schemes, deals, etc., provided to the customer are not uniformly applied to all customers that enter the retail store, but instead are applied, computed and targeted on a unique basis, specifically for that one customer based on his or her CDD profile.

The customer's wireless mobile device would be one that includes a rich interface. A wireless mobile device may be for a mobile phone, a personal digital assistant (PDA), a hand held computer, a wireless video or camera device, an RFID device or other reasonable facsimile or derivation thereof. Such a wireless mobile device may also include a device capable sending or receiving information via the 802.11 standard, CDMA, TDMA, PCS, G3, RFID or any other wireless standard that could be adapted to a user's wireless mobile device. An exemplary network or platform for the system may incorporate a generic platform data server, java application server or other server device or system that provides a generic capability for operating applications thereon. Remote communication between various system servers, components, and a user's mobile device could travel over mobile phone networks, Wi-Fi networks via IP, Wimax networks, via IP, UMA networks, satellite networks or other remote transmission technologies including derivations and facsimiles thereof. When a customer approaches the end of their shopping experience at the retailer's store, an exemplary system provides the means of realizing the applicable customized offerings, coupons or discounts that the customer utilized. Such applicable discounts could be in the form of coupons, electronic coupons, printable recipes, instruction formats, or other means. The coupon and discount aspect of embodiments of the present invention will be described further below.

Additional embodiments of the present invention may provide a systemic backbone for other value added services, such as on-demand video or music that is selected by and delivered to the customer during their in-store stay.

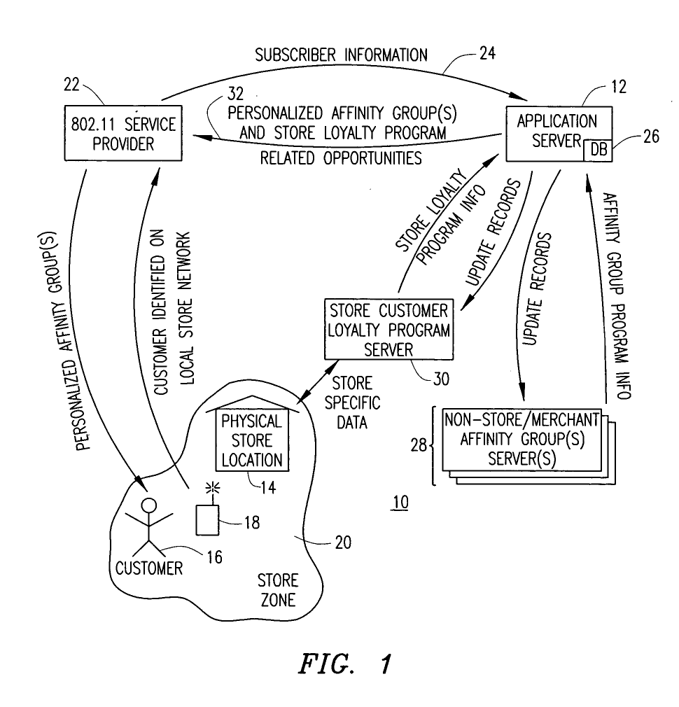

Referring now to FIG. 1, an exemplary system 10 in accordance with an embodiment of the present invention is depicted. An application server 12 operates the majority of the applications and programs responsible for handling and moving data about and within the system. The application server 12 can be located substantially anywhere and can be in communication with the other servers and systems within the system via a wired or wireless communication network.

A physical store location 14 can be any brick and mortar store location or even a kiosk within a mall or other retail establishment. A customer 16 who has a mobile device 18 may walk or enter a store zone 20. The store zone 20 is the area in and perhaps about the physical store location 14 in which a wireless signal, associated with an embodiment of the present invention, can be received by the customer's mobile device 18. The wireless signal may be generated by an antenna in or near the physical store location (i.e., an 802.11 standard type signal) or may be generated by a mobile phone or RFID related communication system. A physical store location may have more than one zone.

As the customer and his mobile device 18 enter the zone 20, a signal from the customer's mobile device 18 is received within the zone 20 by, for example, the 802.11 service provider 22. Again, it is noted that an 802.11 service provider 22 is not necessarily required, but instead in other embodiments of the invention, a telephone service provider that incorporates a location service and knows when a user's mobile device 18 is within the zone 20 could also be utilized.

The customer's mobile device 18 is identified by the service provider 22 and is thus identified or noticed on the physical store location's local network. The physical store location's local network may also be considered the zone 20. The customer's subscriber information 24 is passed from the service provider 22 to the application server 12. The customer's subscriber information 24 may be any one of numerous types of identification information. The customer's subscriber information 24 could be a MAC address associated with the customer's mobile device 18. The customer's subscriber information could also include for example, a customer identification number or the customer's telephone number, social security number, driver's license number, customer loyalty program number, a META TAG ID, or any other unique or substantially unique identifier that could be associated with the customer 16 and/or the customers mobile device 18.

The customer's subscriber information 24 is provided to the application server 12, wherein the customer 16 is identified. The application server 12 then initiates a process wherein a software module, modules or program begin an information gathering process. The information gathering process may begin by identifying the customer and searching a database 26 for any and all personalized affinity groups 28 or store loyalty programs that the identified customer 16 is associated with. Various historic information about the identified customer may already be present in the application server's related database 26. The application server 12 will then contact the servers or database of various affinity groups 28 that the identified customer is a member of to receive additional historic information related to the identified customer 16 and those affinity groups 28. The application server 12, if not located at the retail location, will also contact the physical store location 14 for their particular customer loyalty program server 30 in order to receive additional historic and customer related information about the specific customer 16. In other words, the application server 12, after identifying the specific customer 16, uses the database 26 to query the various affinity groups and their databases 28 in order to retrieve information about the specific customer 16. The information about the specific customer may be used to determine what types of coupons, incentives, information, etc., that could be provided to the customer 16 while the customer is in the physical store location 14 and it's zone 20.

For example, if the customer 16 was at a physical store location 14 where he or she was a member of their grocery store rewards program, the buying habits of the customer 16 would be provided to the application server 12 by the store's customer loyalty program server 30. Furthermore, if the same customer 16 was a member of an affinity group, such as Weight Watchers, the application server 12, via the database 26, will recognize that this particular customer 16 is a member of an affinity group called Weight Watchers. The application server 12 will then contact the Weight Watcher's affinity group server 28 to retrieve information specifically targeting the types of products or services that this customer 16 might be interested in as well as other weight watcher offerings. For example, the Weight Watcher affinity group might provide recipes, coupons or certain types of food that this particular customer 16 is interested in eating during the course of their diet program. The Weight Watcher affinity group may also be providing coupons for a new product line that the customer may or may not have an interest in trying.

After receiving CDD information from the database 26, the store's program loyalty server 30, and/or other affinity group servers or databases 28, the application server 12, using a market intelligence module, program or engine, uses the specific customer's CDD to create, assemble and deliver specific messages, in real time, to the particular customer 16. The messages may include personalized affinity group and store loyalty program related opportunities in the form of coupons, recipes and directions to particular locations in the store or other useful information that the customer 16 may be interested in based on the history and affinity group information associated with the customer 16.

Furthermore, the application server might have a marketing association module, or engine that interprets information about the specific customer 16 and determines that there is a probabilistic possibility that this particular user/customer will make particular psychological based selections based upon a combinational analysis of the user's purchasing history and affinity group memberships. For example, there may be a statistical or probabilistic determination that can be made from the specific customer's CDD, which indicates that this particular customer drives a Ford pick-up truck and is in Weight Watchers, and flies on American Airlines to cities such as Detroit and New York. The statistical or probabilistic determination may be that a customer with this CDD is more interested in purchasing a certain type of food, such as hamburger rather than other types of foods, such as tofu products. As such, the application server may determine that the particular customer 16 should be provided an incentive or coupon to purchase ground beef at a discounted price, even though the particular customer has no history of purchasing ground beef at this retail location.

The personalized affinity groups and store loyalty program opportunities 32 that were established by the application server 12 are sent back to the wireless service provider 22 and then provided in a format that is receivable by the specific customer's mobile device 18. As such, the customer specific opportunities are then displayed for the customer 16 to view while they are within the physical store location 14 and/or zone thereabout the store.

The customer's mobile device will indicate that a message or call needs the customer's attention. The customer may then review the coupons, incentives, marketing material or other information provided by the exemplary system 10 on his or her mobile device 18. The customer may mark, check or otherwise indicate an interest in one or more of the offers presented. If the customer accepts any of the offers on his mobile device 18, the software may present instructions to the customer 16 on where in the physical store location 14 that those items can be located. Instructions may include general location or be as detailed as store section, aisle and shelf. In addition to single product item offerings, the offers presented to the customer 16 on the mobile device 18, may consist of an aggregate of items that are representative of a list or a group of other items. For example, a recipe may be provided and a listing of the necessary ingredients to prepare that recipe would be displayed on the mobile device 18. In another embodiment wherein the physical store location 14 is a hardware store or lumber location, the instructions for how to build a deck and calculations for the materials needed to prepare a deck, may be provided to the specific customer so that the customer could select the appropriately needed materials while at the hardware store.

When the customer 16 is checking out of the physical store location 14, a listing of items purchased by the customer 16 are provided to the store customer loyalty program server 30 from the physical store location 14 and the selected items that the customer 16 requested a discount on, would be appropriately discounted from the customer's purchase. Furthermore, information or a listing about the items purchased, coupons or offers used or not used, coupons or offers reviewed or passed over by the customer are provided to the application server 12 and used, perhaps by a marketing group, to track the effectiveness of the real time marketing of the products being offered in the form of spontaneous buying opportunities on the customer's mobile device 18 at the retail location. Such information could be used to evaluate what type of real time opportunities operate and drive a particular type of customer 16 to purchase a particular manufacturer's brand at the moment of the buying decision, in real time, and at the retail location.

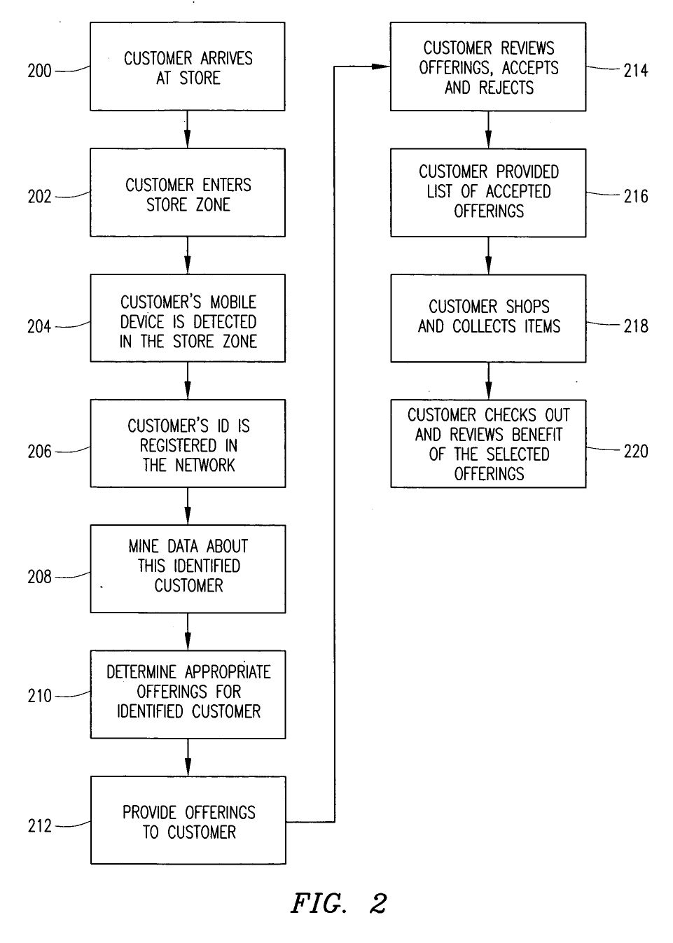

Referring now to FIG. 2, an exemplary method of providing a real time offering to customers while in a store zone, in accordance with an embodiment of the present invention is provided. In essence, a method, in accordance with an embodiment of the present invention, allows a retailer to provide a unique shopping experience to their customers through the use of one or more instant delivery coupons (IDC). As a customer approaches or enters a retail location 200, they may also be entering a store zone 202. Once in the store zone 202, the customer's mobile device, may identify the store zone as being one of a number of participating retail locations. That is, the store zone 202 that the consumer is in may be one that the consumer has previously registered with. Conversely, at step 204, the customer's mobile device may be detected in the store zone 202 by a wireless communications system. Either way, at step 206, the customer's identification, which is provided from the customer's mobile device, is registered in the store zone's network.

A mobile device that would most likely perform the best in embodiments of the present invention would be one that would include a “rich interface” so that a variety of different types of data and protocols can be transmitted and received by the mobile device. Less sophisticated wireless or mobile devices may also be used. Such mobile devices include, but are not limited to, mobile phones, personal digital assistants, hand held computers, wireless video devices, wireless camera devices, wireless audio devices, RFID devices, wireless network device and/or combinations or derivations of the same. Such remote or wireless communication between the consumer's mobile device and between any of the elements of an exemplary system may be over a communication means such as a mobile phone network, a Wi-Fi network, a Wimax network, a UMA network, a satellite network, a network using an 802.11 communication standard, or any other remote transmission technology that is available.

Still at step 206, the customer's mobile device may automatically register with the in-store network or zone via location aware software residing on the customer's mobile device and a supporting infrastructure system within the retail or store location and zone.

The registration of the customer would include a customer identification that is unique or substantially unique to the customer and ties the customer to their previous shopping history, personalization settings and affinity groups. As discussed above, items that may be used an identification of the customer may be the customer's mobile device MAC address, telephone number, RFID code, drivers license number, service provider number, tax identification number, name or any other identifying data string. The customer identification number will ideally identify the specific customer individually, but may be used to identify a family or group of customers that are associated with the customer's mobile device.

At step 208, the application server or other device mines information and historic data about the identified customer. The data mining can incorporate any public information searched for and found that is related to the identified consumer. Such information may include information from the store's customer loyalty program that the consumer may have signed up for and indicated their interests and disinterests. The store's customer loyalty program may also provide a historic or statistical buying history of this particular customer. Furthermore, the mining of data may include looking at information about the identified customer from affinity groups that the customer has indicated that they are signed up for. Such affinity groups may be airline mileage groups, wholesale discount groups, credit card companies, hotel or travel clubs, pet supply clubs, internet related retailers, or any other affinity, hobby or desired group that a customer may be member of that may provide an indication of the specific customer's, or group of customers', likes, dislikes and interests. At step 210, the application server operates marketing and analysis modules or software to determine appropriate offerings for the CDD of the identified customer. Such offerings would be based on the identity of the customer and his or her CDD, which may include relevant demographic, affinity and historical buying behaviors and other related information available to the application server about the customer. The CDD is access and assembled in real time as the identified customer enters the zone of the physical store location. The CDD profile is used by a marketing intelligence engine, module or program that derives and assembles specific messages with which to target and provide to the customer. The messages provided to one customer via his mobile device will more than likely be somewhat different from messages provided to another customer's mobile device because they are derived from different user's or customer's CDD.

In the case of the physical store location being a retail store, the specific messages at step 212 could be daily, weekly or monthly in store specials, offerings, and coupons for items or services at the specific physical store location. The specific specials, coupons or offerings are provided to the customer via the customer's mobile device.

At step 214, the customer's mobile device, after receiving the messages, may attract his or her attention by whatever means the mobile device is capable of or has been set for. For example, the mobile device may provide a audible alert, a vibration or a visual alert to attract the attention of the identified customer. The customer who would preferably be signaled by their mobile device when first entering the zone of the store location, but may be signaled at any time or multiple times while in the store location. The customer at step 214, reviews the offerings via the display on their mobile device. The customer may select coupons that he or she wants, and can skip or not select coupons or special offerings that he or she does not want. The list of coupons that are selected by this customer may be tied together with a reference number and an associated barcode or other visual, optical, audible or wireless signal. At step 216, a customer is provided a list of accepted or selected offerings and at step 218, the customer may shop and collect some or all of the selected items.

Again, the list of coupons that were selected by the customer may be tied together with a reference number and/or a barcode or other coupon indicia. The barcode may act as a meta coupon and is the access key to retrieve other coupon information at check out time. At step 220, when the customer checks out, the barcode may be displayed on the customer's mobile device and read by a barcode reader at checkout. As such, the customer's selected discounts would be provided to the customer. If the coupon indicia is an optical, audible or wireless signal, the customer may have his or her mobile device produce the coupon indicia so it can be read at checkout (i.e. the point of sale) by a coupon indicia reading device (not specifically shown). The customer's mobile device may only need to be identified at the point of sale for the customer to obtain any discounts that were selected earlier while in a zone within the retail store.

Alternatively, a coupon could be printed out inside the retail location and collected by the customer while they are shopping. In other embodiments of the invention, the discounts are automatically provided to the customer based on the customer's selection of coupons in step 214. The customer's selection was transmitted from the mobile device, via the zone's wireless communication system, to the application server and onto the physical store location's system so that at checkout the applicable discounts or deals would be applied to the customer's bill.

In additional embodiments of the invention, the mobile device software in conjunction with the application server provided information can provide in-store directions to the customer so that items that were selected and/or identified on the coupon list can be easily found within the physical store location. Directional information could include store area, aisle and shelf location so the items can be found quickly.

As an alternative to a simple list of discount items presented for selection on the customer's mobile device, the suggested items for purchase at step 214 could be collected on a subject basis. For example, based on the CDD profile of the customer, the system could propose a recipe that the customer may enjoy. The customer could select that recipe and all the retail items associated with the recipe could be on a list, potentially with a discount on each of them, for the customer to select from. In another example, if it was determined in the CDD profile that the customer enjoyed yard work and caring for their lawn and garden, the software running on the application server may determine that it is the spring time of the year and it is time for the customer to purchase certain types of fertilizer, chemicals, seeds and plants that could be planted in the customer's yard or garden at this time of year. Thus, the application software may take into account the time of year and/or date that the customer is shopping in the store.

With respect to providing the customer a recipe, the customer's electronic device may also store the recipe for later use, so that the customer may use that recipe when they make the meal at home.

In addition to dynamic affinity suggestions, customers could pre-set certain aspects or interests which add to the exemplary system's ability to personalize the choices provided to the customer, such as dietary restrictions for diabetes or religious beliefs, weight loss programs, specific manufacturer product preferences or other customized preferences that can be used to filter the offerings presented by the application server software or displayed by the customer's mobile device.

In another embodiment of the invention, an additional premium service could be provided for the use of the customer, so that the customer could compare prices of items that he or she has selected to purchase at their present physical store location with the same or similar items at other retail locations within a certain predetermined or customer selected mile or geographic distance range. This would be useful to the customer who likes to comparison shop. The comparison may also allow the customer to compare brand name items found at the retail location with the same or similar items that can be ordered by mail order or via an internet merchandising site.

Referring back to step 220, at checkout, either the printed or mobile device displaying or electronically providing the coupon could be scanned. The barcode or “meta-coupon” could access the list of offerings the customer selected, reconcile them with the scanned items and apply the discount. The purchasing information would be stored along with a reference to the customer loyalty and affinity information for this particular customer. Such information would be stored back in the store's customer loyalty program server 30 and/or the application server database 26. The customer loyalty and affinity information can be used to track the effectiveness of the real time marketing of the products being offered. It could also be used to track the probability of a spontaneous purchasing response to a buying opportunity presented to a customer having certain affinity relations and buying histories. The information could also be used to evaluate future opportunities for driving a particular manufacturer's brand preference, in real time, at the moment when a buying decision is made. For example, if a customer has a history of purchasing Coca Cola® and a coupon is provided for Pepsi® at a deeply discounted price, an exemplary system can record the level of discount that could sway a customer to purchase a product brand that they do not normally purchase.

In yet other embodiments of the invention, when the customer is provided offerings at step 212, a first level of discount may be provided to the customer if they do not review the offerings. A second level of discount, perhaps a greater discount than the first level of discount, may be provided to the customer if the offerings are reviewed. A third and deeper discount may be provided to the customer if the customer not only reviews the offerings but selects particular items or offerings that they plan on purchasing during that visit in the physical store location. Such a technique would create an incentive for a customer to review the electronically provided coupons on their mobile device at the time they entered the store and make decisions, impulsive or otherwise, on what they plan to purchase while in the store.

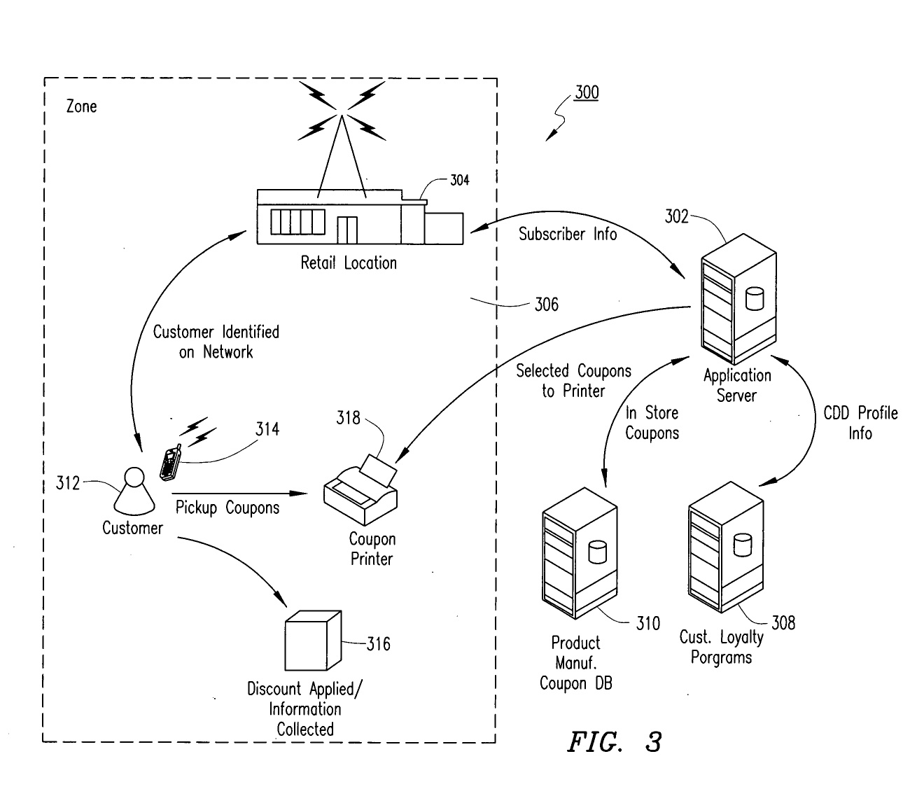

Referring now to FIG. 3, another exemplary embodiment of the present system 300 and method are depicted. An application server 302 is provided. The application server could be a specialized server, but a generic application server, such as a java application server operating, for example, JBOSS and wherein provides a generic capability for running applications associated with the exemplary system could be used. The application server 302 is in communication with a retail location 304. The retail location may be any retail location that provides products or services to consumers. The retail location may have an antenna or other wireless related system in the form of communication cells or pico-cells establishing a zone 306 or zones (not specifically shown) about the retail location 304. The zone 306 is an area that determines whether a consumer's wireless device is within the area and communicates between the system 300 and the customer's wireless device 34. The zone 306 may be considered part of the system 300 in some embodiments of the invention. The application server 302 is also in communication with a customer loyalty server 308, which is associated with the retail location and provides historic purchase and buying trends of customers who frequent the retail location 304. The application server 302 is also in communication with a product manufacturer's coupon database 310, which provides information, to the application server 302, about what coupons or special offers are available for products in the retailer's location. It is understood that the application server may be in communication with a plurality of retail locations 304, all of which may be operating under the same name or they may be operating under different names, but are using a service provided by an embodiment of the present invention. Furthermore, the application server 302 may be in communication with a plurality of customer manufacturer coupon databases and/or customer loyalty program devices 308, each being associated with different customer affinities or consumer services that the customer is subscribing to or signed up for. The application server 302 may be connected to a wide variety of information, data, a database source to enable its marketing engine to obtain information about market trends, geographic trends, cultured trends, facts and other related customer and marketing data.

As a customer 312 enters a zone 306 or a retail location 304, the customer's mobile device 314 registers itself within the retail location zone 306. The customer is identified on the retail location's network via a customer's unique ID. The customer's unique ID may also be used to identify a family or group of customers associated with the mobile device 314 and then register them on the application server 302. Subscriber information may be passed back and forth between the retail location 304, 306 and the application server 302.

After the specific customer is identified, the application server 302 begins to mine the historic information and affinity groups that the customer 312 is a member of. The application server 302 contacts the customer loyalty programs 308, which may also include additional databases relative to the customer's known affinity groups. The application server 302, via the product manufacturer coupon database 310 and customer historic data, and loyalty programs 308 determines a CDD profile for the customer and applies the CDD profile to a marketing module or engine. The marketing engine uses the CDD and analysis what the customer has historically purchased, what other customers having similar CDD profiles have purchased, what time of day, month, the year it is, what products the retailer and manufacturers are presently pushing or providing coupons or incentives for and then formulates a unique set of offerings for the identified particular customer 312 in real time.

The application server 302, via the retailer's location and zone 306, alerts the user via whatever means the user's mobile device can alert the user that the user is being provided special incentives and coupons relative to their visit and presence at the retail location 304. These offerings may be provided to the user's mobile device as the customer is approaching the store or when just entering the store. The customer is being provided coupon and deal information upon entering the store so that they can have a real time understanding of the special offers at the store while they shop. The information provided to them may help them decide on purchasing additional items that they are interested in, but were not planning on purchasing until reading the message provided to their mobile device 314. In other words, the offerings are being delivered in real time or are “just in time” or tickler offerings to customer 312.

The offerings can be in the form of short video clips, listings, JPEG graphics or other multimedia means for the customer 312 to view on their wireless device 314. The customer may view or flip through the various offerings, selecting the offerings that interest them and saving them to a listing for use while in the store. As a result, the customer 312 will have a personalized coupon list to use and choose from as they shop through the retail location 304. The customer 312 may use the coupon list and software on their wireless device to aid them in locating the particular items on the coupon list so that they can easily find selected items in the store. The directions to the specific elements may be provided via communication between the customer's wireless device 314 and the communication system inside the retail location within the zone 306.

The customer then collects all or some of their selected coupon-items along with other items that they may be purchasing in the retail location 304 and proceeds to the checkout counter 316.

As the customer 312 checks out of the retail location 304 at the cashier or checkout location 316, the selected discounts are applied to the customer's purchase and purchase information is collected for storage in the purchase history database 308.

There are a variety of techniques that are in accordance with embodiments of the present invention for applying the selected discounts to the customer's bill. In one embodiment, the customer is identified by his or her customer identification number and the discount is automatically applied based on what the customer 312 had selected or chosen at the time they entered the store and actually purchased. In another embodiment of the invention, the specific customer chosen or selected coupons are printed out on a printer 318 for the customer to use at the time of checkout. In yet another embodiment, a barcode or other type of machine readable coding technique is displayed on the customer's mobile device and scanned at the point of checkout, thereby providing the information needed for applying the discount to the selected items. In another embodiment, the discount is wirelessly credited to the customer's account or credited to the customers bill.

In another embodiment of the present invention, the zone 306 is divided up into sub-zones or pico-zones (not specifically shown). As the customer enters different zones in the store, different coupons or incentives can be provided to the customer's wireless mobile device 314 for products or services located in the sub-zone or pico-zone that the customer is presently in. Yet, in other embodiments of the invention, a time limit is placed on the coupon or purchasing incentives so that the customer has a limited amount of time to purchase the products being advertised to them. For example, the customer may need to purchase the items provided to them within five hours of first receiving the incentive or coupon. It is understood that the length of time may be any reasonable amount of time for a coupon or purchasing incentive to be valid.

In yet another embodiment of the invention, a multi-level discount could be provided to the customer. As the customer enters the store, a first amount of discount is provided to the customer because their ID has been determined and they are a member of the customer loyalty club for that particular store. A second level of discount may be provided to the customer if they look at their wireless mobile device and potential discounts, coupons and incentives that are personally selected for them based on their CDD (i.e., historic purchases and affinity groups they are members of). A third level of discount may be provided to the customer if they page through the personalized coupons, discounts, and incentives and actually select the items on their mobile device and then purchase the items at the time of checkout. This technique of marketing in accordance with an embodiment of the invention may incentivise a user to peruse all the coupons that are being provided to their mobile device 314 while in the zone 306 of the particular retail location.

It will be appreciated by those skilled in the art, having the benefit of this disclosure, that this invention provides a system and method associated with a retail marketing buying experience, wherein coupons or incentives are provided to a customer at the time that they enter a zone on or about a retail establishment. Such coupons or incentives may be used to market to the customer based on the customer's own affinities and historic purchasing data. The coupons are specifically designed for the customer who has their own identification related and associated with their wireless mobile device. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, embodiments apparent and obvious to those of ordinary skill in the art, without departing from the scope of this invention as defined by the following claims. Thus, it is intended that the following claims be interpreted to embrace all such further modifications, changes, rearrangements, substitutions, alternatives, design choices and embodiments.

What is claimed is:

1. A method of providing customer related messages to a customer, said customer using a mobile device and said mobile device having a customer identification, said method comprising:
entering, by a customer, a store zone;
receiving, by a system, said customer identification from said mobile device;
mining, by said system, customer demographic data (CDD) related to said customer identification;
generating, by said system, messages for said customer, said messages being generated based on said mined CCD related to said customer identification;
providing, by said system, said messages to said mobile device when said mobile device enters said store zone;
requesting that said customer reviews said messages on said mobile device and selects at least one message that interests said customer;
receiving, by said system, a message that was selected by said customer as a customer selection related item;
providing, by said system, a discount to said customer, said discount being applicable when said customer purchases said customer selection related item.

2. The method of claim 1, wherein said store zone is about a store location.

3. The method of claim 2, wherein providing a discount is performed only when said mobile device having said customer identification information is with said customer when said customer purchases said customer selection related item.

4. The method of claim 1, wherein said messages comprise at least one of a coupon, an incentive, and a product offering.

5. The method of claim 1, wherein said discount to said customer is a larger discount if said customer selected said customer selection related item, than if said customer only reviewed said messages and did not select at least one of said messages.

6. The method of claim 1, wherein there are a plurality of store zones for said customer to enter, said store zones being at a store location.

7. The method of claim 1, wherein mining further comprises:
requesting customer identification related information from at least one customer interest affinity database; and
reviewing customer identification related historic purchase habits.

8. The method of claim 1, further comprising providing, by said system to said mobile device for said customer to review, directions to a location for an item associated with said customer selection related item.

9. The method of claim 1, wherein providing comprises printing a coupon for said customer to take.

10. The method of claim 1, wherein providing comprises sending, by said system to said mobile device, a coupon indicia.

11. The method of claim 10, wherein said coupon indicia can be displayed by said mobile device and scanned by a point of sale device.

12. The method of claim 10, wherein said coupon indicia comprises an electronic signal provided by said mobile device at a point of sale.

13. The method of claim 10, wherein said coupon indicia is stored by said system and presented to said customer at a point of sale.

14. A method of providing purchasing incentives to a customer who enters a retail zone with a mobile device, said mobile device containing a customer identification, said method comprising:
identifying said customer by receiving said customer identification from said mobile device when said customer and said mobile device are in said retail zone;
providing, to said mobile device, a plurality of purchasing incentives, said plurality of purchasing incentives being based on the customer's purchasing history and at least one of the customer's affinity memberships, said purchasing incentive being provided to said mobile device for the customer to review upon entering said retail zone;
requesting that said customer review said plurality of purchasing incentives;
requesting that said customer select at least one of said purchasing incentives as a customer selected purchasing incentive;
providing a discount to said customer at a point of sale that is related to said retail zone, said discount being associated with said customer selected purchasing incentive;
storing information about the customer's purchases and usage of said plurality of purchasing incentives.

15. The method of claim 14, wherein said purchasing incentive are in the form of at least one of a text, graphics and video media.

16. The method of claim 14, wherein said customer receives a first discount for reviewing said plurality of purchasing incentives and wherein said customer receives a second discount for selecting at least one of said purchasing incentives.

17. The method of claim 14, wherein at least one of said purchasing incentives originated from a real time link from at least one of a customer's affinity membership computer system.

18. The method of claim 14, further comprising providing said stored information about said customer's purchases and usage of said plurality of purchasing incentives to a marketing group.

19. The method of claim 14, further comprising providing directions to said mobile device to aid said customer in finding an item that is a topic of said customer selected purchasing incentive.

20. A method of purchasing retail items with electronic coupons, said method comprising:
providing, to a user's mobile device, a plurality of electronic coupons as said user's mobile device enters a predefined zone, said electronic coupons being at least in part a result of customer demographic data that is directly associated with the user of said user's mobile device;
reviewing, by said user on a display of said mobile device, said plurality of electronic coupons;
selecting, by said user via said mobile device, at least one of said electronic coupons;
providing, to said user via said mobile device, an option to receive directions to help locate an item associated with a selected one of said plurality of said electronic coupons;
providing a discount, to said user at a point of sale associated with said predefined zone, based on said selected one of said plurality of said electronic coupons.
